(19) United States
(12) Patent Application Publication
(10) Pub. No.: US 2016/0164326 A1
(43) Pub. Date: Jun. 9, 2016

(54) CHARGING DEVICE

(71) Applicant: Gemtek Technology Co., Ltd., Hsinchu (TW)

(72) Inventors: Hung-Wen Chen, Hsinchu (TW); Seng-Ruen Chow, Hsinchu (TW)

(21) Appl. No.: 14/619,083

(22) Filed: Feb. 11, 2015

(30) Foreign Application Priority Data
Dec. 9, 2014 (TW) 103221838

(51) Int. Cl. H02J 7/00

(52) U.S. Cl. CPC H02J 7/0047; H02J 7/0021; H02J 7/0027; H02J 7/0052; H02J 7/007

(57) ABSTRACT

The present invention provides a charging device fixed or placed on a table or a wall to serve as a signage, the charging device includes a display unit for displaying information, a power supply unit for providing power to the charging device, and a charge connector, wherein when an external electronic device is connected to the charge connector, the power supply unit charges the external electronic device via the charge connector.

### BACKGROUND OF THE INVENTION

1. Field of the Invention

The present invention relates to a charging device, and more particularly, to a multifunction charging device.

2. Description of the Prior Art

Conventionally, the table cards/table signage placed on the tables of a restaurant or a conference room are usually only for displaying associated information without other functions, therefore, if a table card/table signage can combine with other functions, it can solve some inconvenient situations for users and also can achieve more goals.

### SUMMARY OF THE INVENTION

The present invention provides a charging device which can be fixed or placed on a table or a wall to serve as a signage, and has a display unit to display associated information. Therefore, because it combines the functions of the charging device and the table card/table signage, it can bring more convenience to users.

According to an embodiment of the present invention, a charging device which is fixed or placed on a table or a wall to serve as a table card/table signage is disclosed. The charging device comprises a display unit for displaying information, a power supply unit for providing power to elements within the charging device, and a charger connector, wherein the power supply unit comprises at least one of a mobile power bank, a detachable power bank component, a battery module and a power supply module. When an external electronic device connects to the charger connector, the power supply unit charges the external electronic device via the charger connector.

According to another embodiment of the present invention, a charging device which is fixed or placed on a table or a wall to serve as a table card/table signage is disclosed. The charging device comprises a display unit for displaying information, a power supply unit for providing power to elements within the charging device, wherein the power supply unit at least comprises a wireless charging module, and when an external electronic device is placed in a charging range of the wireless charging module, the wireless charging module charges the external electronic device.

In addition, in other embodiments of the present invention, the display unit is further arranged to display image data from a cloud server, the charging device with function of charging further comprises an electronic element to avoid theft and/or comprises a signal feedback unit for controlling a lever of power consumption of the display unit.

On the other hand, in other embodiments of the present invention, the charging device can also have a function of multimedia communication, that is, except for receiving the image data via a wireless communicating unit and displaying it on the display unit, the charging device can communicate with other electronic devices via a speaker and a microphone included within the charging device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a charging device according to an embodiment of the present invention.

FIG. 2 is a diagram illustrating the appearance of a charging device according to one embodiment of the present invention.

FIG. 3 is a diagram illustrating the appearance of a charging device according to one embodiment of the present invention.

FIG. 4 is a diagram illustrating controlling image information displayed by a charging device according to an embodiment of the present invention.

FIG. 5 is a diagram illustrating a charging device according to another embodiment of the present invention.

FIG. 6 is a diagram illustrating a charging device used in a conference occasion.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

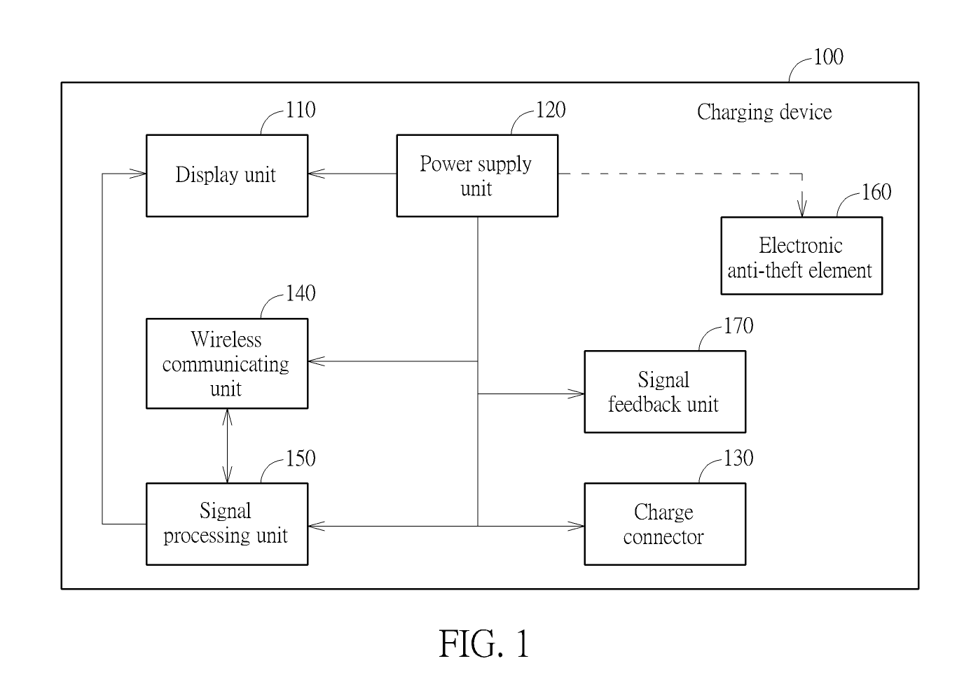

Refer to FIG. 1, which is a diagram illustrating a charging device 100 according to an embodiment of the present invention. As shown in FIG. 1, the charging device 100 comprises a display unit 110, a power supply unit 120, a charge connector 130, a wireless communicating unit 140, a signal processing unit 150, an electronic anti-theft element 160 and a signal feedback unit 170. In this embodiment, the charging device 100 is arranged to be fixed or placed on a table or a wall to serve as a signage. For example, the charging device 100 can be a portable device and be placed on a table of a conference room or a restaurant or any table needs a table signage; the charging device 100 can be fixed on any table needs a table signage with screws, clippers (or clamping fixture) or other tools; in addition, the charging device 100 can also be fixed on a wall to serve as a signboard.

In the charging device 100, the display unit 110 comprises at least one of a digital electrical signboard, transparent plate, a liquid crystal display (LCD), a light emitting diode display screen and a signage, that is, the display unit 110 can be a display device that needs electric power to perform image display or a display unit that only has a paper positioned between the transparent plate to display information (in this embodiment, the display unit 110 uses electric power to perform image display as an example). The power supply unit 120 comprises at least one of a mobile power bank, a detachable power bank component, a battery module and a solar power supply unit for providing the power to elements included within the charging device 100. The charge connector 130 is arranged to connect to an external electronic device, and when the external electronic device is connected to the charger connector 130, the power supply unit 120 charges the external electronic device via the charge connector 130, wherein the spec of the charge connector 130 can be one of the specs that can charge the connected external electronic device. The wireless communicating unit 140 comprises an antenna and a wireless transmitting interface circuit for performing the internet connection, more particularly, for connecting to the internet to receive display data from a cloud server. The signal processing unit 150 can be formed by one or a plurality of chips and associated elements for processing internal signals of the charging device 100 and controlling data displayed by the display unit 110, more particularly, for processing the data from the cloud server then displaying the processed data on the display unit 110. The electronic anti-theft element 160 can be any electronic element which can locate a location or an electronic label/tag with Radio Frequency Identification (RFID) function for preventing the charging device 100 from being stolen and brought out the occasion it's placed in. In addition, the signal feedback unit 170 is arranged for controlling open/close state of the display unit 110 or controlling the level of power consumption of the display unit 110 (e.g. controlling the luminance of the monitor of the display unit 110).

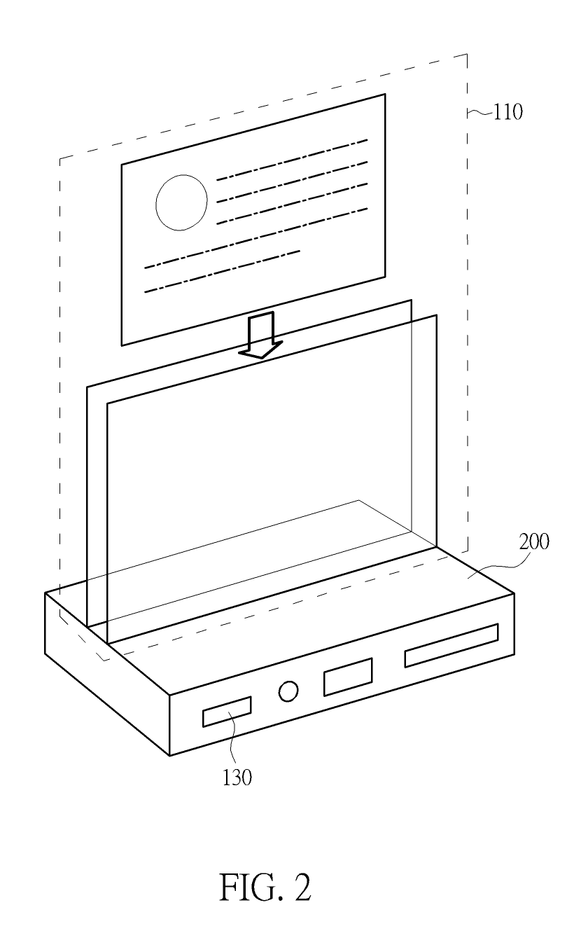

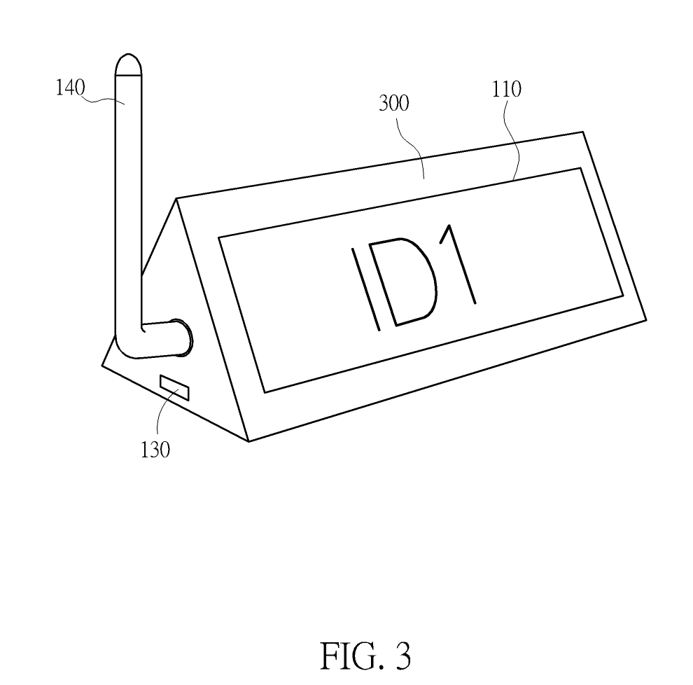

Refer to FIG. 2 and FIG. 3, which are diagrams illustrating the appearance of the charging device 100. In FIG. 2, the appearance of the charging device 100 looks like an acrylic table card in restaurant, wherein the two acrylic boards above are arranged to place commercial papers as the display unit 100 shown in FIG. 1, and the outside of the under case 200 has the charge connector 130 for providing power for users, and the other elements of the charging device 100, e.g. the power supply unit 120, the electronic anti-theft element 160, etc. are all installed in the case 200. In FIG. 3, the appearance of the charging device 100 is a triangular table card which the front side has a display device served as the display unit 100 to display image, the outside of the case 300 has an antenna of the wireless communicating unit 140 and the charge connector 130 for providing power for users, besides, other elements of the charging device 100 are installed in the case 300, e.g. the signal processing unit 150, the electronic anti-theft element 160, the signal feedback unit 170, etc. It should be noted that what the charging devices 100 shown in FIG. 2 and FIG. 3 are only examples, and the person skilled in this art should understand the charging device 100 can have any other appearance.

In the charging device 100 of the present invention, when the charging device 100 is installed in a restaurant or a conference room as a table card, because the present invention has the charge connector 130, customers in the restaurant or users in the conference room can charge their electronic device (e.g. cell phone or tablet) to enhance the convenience. Specially, in the embodiment, the charge connector 130 is only arranged for charging the connected external electronic device, that is, the charge connector 130 does not have other functions but for charging, and the charge connector 130 is functional- and operational-unrelated to the wireless communicating unit 140, the signal processing unit 150, the electronic anti-theft element 160 and the signal feedback unit 170 of the charging device 100. However, in other embodiments, the charge connector 130 can have the function of signal transmission simultaneously, and these alternative designs should fall within the scope of the present invention.

In addition, the charge connector 130 can be the charge connector on the case of the charging device 100, but for the users' convenience, the charge connector 130 can be the charge connector connected to the charging device 100 via a transmission line and corresponds to the specs of the Micro USB.

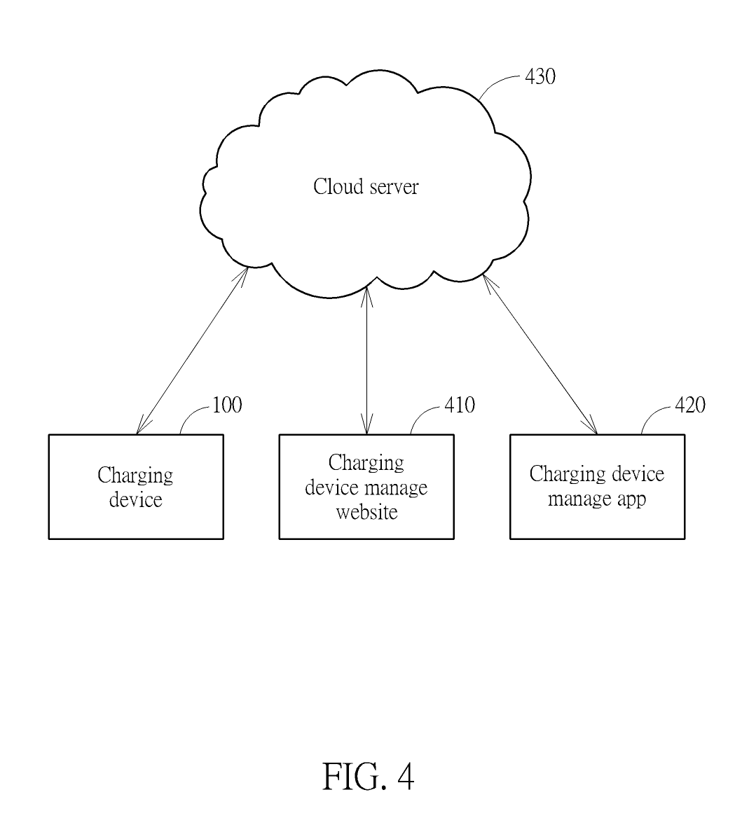

In addition, refer to FIG. 4, which is a diagram illustrating controlling image information displayed by a charging device 100 according to an embodiment of the present invention. As shown in FIG. 4, a charging device manage website 410 is a website provided by a cloud server 430 for editing/controlling the image data displayed by the charging device 100, and the manager can use a personal computer device (e.g. desktop computer, laptop, tablet or any device can connect to an external website via the internet) to connect to this website; the main function of a charging device manage app 420 is the same as the charging device manage website 410 for the manager to edit/control the image data displayed by the charging device 100 with a smart phone or a tablet. In addition, the charging device 100 can receive the display content edited/decided in the cloud server 430 by user, and displays the received image data on the display unit 110.

For example, when the charging device 100 is installed on a dining table in a restaurant, the restaurant manager can edit the image content displayed on the charging device 100 via the charging device manage app 420 in a smart phone or a tablet after keying in the corresponding username and password. When the restaurant manager finishes and confirms the edit, the charging device 100 can receive the needed display information from the cloud 430 and displays it on the display unit 110. It should be noted that the charging device 100 can connect to the cloud server 430 anytime to receive the latest display information, and the charging device 100 can also start to receive display information from the cloud server 430 after receiving an indicating signal generated by an electronic device used by the restaurant manager. These alternative designs should fall within the scope of the present invention.

In another embodiment, except receiving the display information from the cloud server 430, the charging device 100 can receives audio data from the cloud server 430 as well to make the charging device 100 use the internal speaker to transmit the audio data.

The cloud server 430 described in FIG. 4 is only an example, in other embodiments of the present invention, the cloud server 430 can be any other servers or other manage electronic devices.

In addition, because the power supply unit 120 of the charging device 100 can comprise high value components like a mobile power bank, a detachable power bank component, a battery module, etc. Therefore, to decrease the theft rate of the charging device 100, the charging device 100 installs the electronic anti-theft element 160 for prevent the charging device 100 from being stolen and brought out the occasion it's placed in. For example, the electronic anti-theft element 160 can be an electronic label/tag and the manager can install a gate for sensing the label/tag at some specific locations, e.g. by the restaurant door. When the gate senses the electronic label/tag, it makes sounds or through other ways to notify the manager the charging device 100 might be stolen. In addition, the electronic element 160 can also be a burglarproof magnetic strip, RF soft anti-theft barcode, AM DR soft anti-theft label, acoustic magnetic anti-theft label or comprise at least one of these above-mentioned anti-theft elements.

In this embodiment, the signal feedback unit 170 can comprise physical button, touch panel and/or associated signal control circuit to control the open/close state of the display unit 110, or control the level of power consumption of the display unit 110 (e.g. control the luminance of the screen of the display unit 110). However, in other embodiments, the open/close state of the display unit 110 or the level of power consumption of the display unit 110 can be remote controlled by the manager, that is, the manager can generate the control signal by a mobile device for controlling the display unit 110 via the wireless communicating unit 140 and the signal processing unit 150.

The elements included within the charging device 100 shown in FIG. 1 are only an example, in other embodiments of the present invention, the wireless communicating unit 140, the signal processing unit 150, the electronic anti-theft unit 160 and the signal feedback unit 170 are optional elements, that is, without affecting the operations of the other elements, the above-mentioned elements can be selectively removed from the charging device 100 according to the consideration of the designer, these alternative designs should fall within the scope of the present invention.

In addition, in another embodiment of the present invention, when the power supply unit 120 charges the external electronic device with the wireless charging module, the charge connector 130 shown in FIG. 1 can be removed from the charging device 100, and in this time, the user only needs to put the electronic device in the charging range of the wireless charging module.

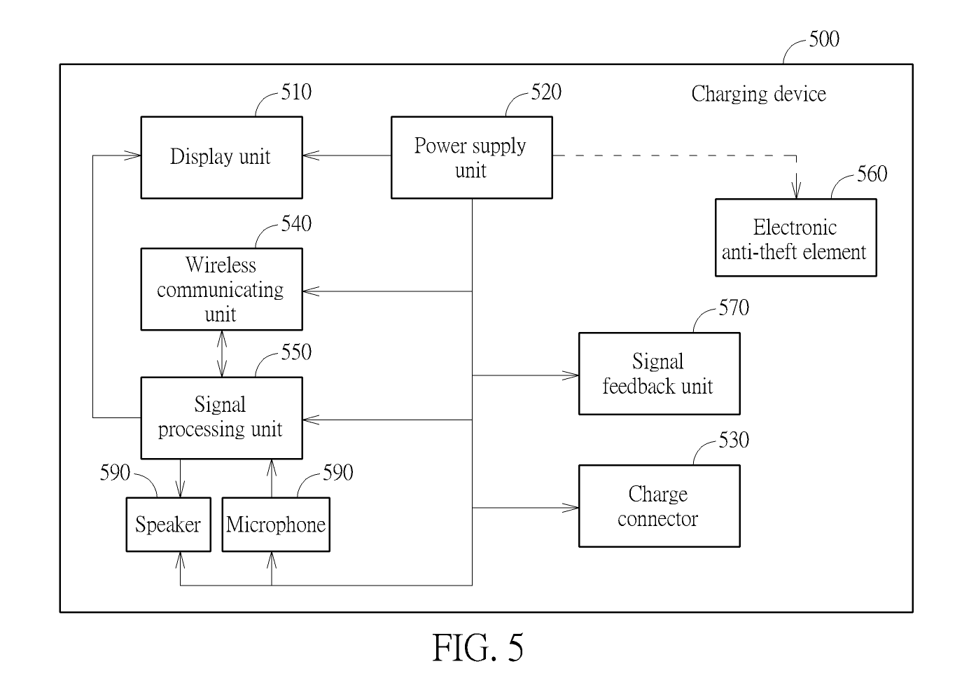

Refer to FIG. 5, which is a diagram illustrating a charging device 500 according to another embodiment of the present invention. As shown in FIG. 5, the charging device 500 comprises a display unit 510, a power supply 520, a charge connector 530, a wireless communicating unit 540, a signal processing unit 550, an electronic anti-theft element 560, a signal feedback unit 570, a speaker 580 and a microphone 590. In this embodiment, the charging device 500 is fixed or placed on a table or a wall to serve as a signage. For example, the charging device 500 can be a portable device and be placed on a table of conference room, a restaurant or any table that needs a table signage; the charging device 500 can be fixed on any table that needs a table signage with screws, clippers (or clamping fixture) or other tools. In addition, the charging device 100 can also be fixed on a wall to serve as a signboard.

In the charging device 500, the functions and the operations of the display unit 510, the power supply unit 520, the charge connector 530, the wireless communicating unit 540, the signal processing unit 550, the electronic anti-theft element 560, the signal feedback unit 570 are identical with the display unit 110, the power supply unit 120, the charge connector 130, the wireless communicating unit 140, the signal processing unit 150, the electronic anti-theft element 160, the signal feedback unit 170 shown in FIG. 1, respectively, so the associated contents and embodiments are omitted here. In addition, the charging device 500 further comprises the speaker 580 and the microphone 590 for communicating. In detail, in some situations, e.g. in a conference room or a restaurant, the user might need to communicate with the manager or other people, in this time, the wireless communicating unit 540 can receives the external audio data from the manager or other electronic devices, then the signal processing unit 550 processes the received external audio data and transmits it to the speaker 580 to play. On the other hand, the wireless communicating unit 540 can also receive the audio data (the content of speech of the user) from the microphone 590 and send the audio data via the wireless communicating unit 540 to the manager or other people.

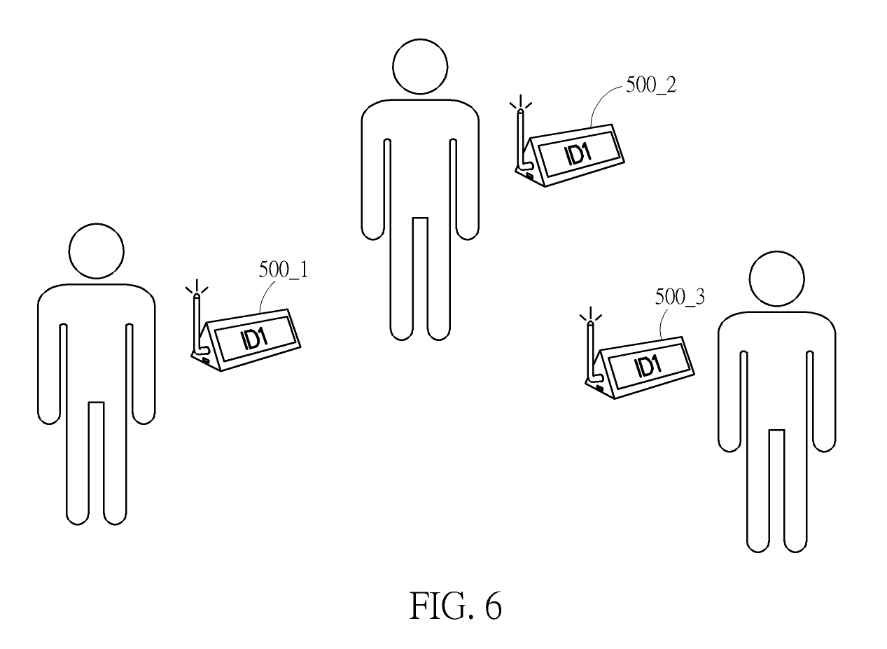

Refer to FIG. 6, which is a diagram illustrating a charging device 500 used in a conference occasion. In FIG. 6, it is assumed that there are charging devices 500_1, 500_2, and 500_3 respectively installed on three users' tables, wherein the each of the charging devices 500_1, 500_2, and 500_3 is the charging device 500 shown in FIG. 5. Three users can communicate with each other via the charging devices 500_1, 500_2, and 500_3 in front of them, and the display units of the charging devices 500_1, 500_2, and 500_3 can also display associated information to the users simultaneously. In addition, if the power of the user's mobile device is too low, the user can charge the mobile device with the charging devices 500_1, 500_2, and 500_3. As described above, because the charging device 500 can be applied to be a table card in a conference room, and has the function of image display and multilateral communication, and can be used to charge the user's mobile device at any time, the convenience of the user can be considerably increased thus.

Briefly summarized, the charging device of the present invention can be fixed or placed on a table or a wall to serve as a signage, and has a display unit to display associated information, therefore, combining with the functions of charging device and the table card/table signage, it can bring more convenience to users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charging device, fixed or placed on a table or a wall to serve as a signage, comprising:
a display unit, arranged to display information;
a power supply unit, arranged to provide power to the charging device; and
a charge connector;
wherein when an external electronic device is connected to the charge connector, the power supply unit charges the external electronic device via the charge connector.

2. The charging device of claim 1, wherein the charge connector is dedicated to charging the connected external electronic device.

3. The charging device of claim 1, wherein the power supply unit comprises at least one of a mobile power bank, a detachable power bank component, a battery module or solar power supply module.

4. The charging device of claim 1, wherein the display unit comprises at least one of a digital electronic signboard, a transparent plate, a liquid crystal display (LCD) screen, a light emitting display (LED) screen and a signage.

5. The charging device of claim 1, further comprising:
a wireless communicating unit;
a signal processing unit, coupled to the wireless communicating unit, arranged for communicating with other electronic devices via the wireless communicating unit, and processing received data via the wireless communicating unit.

6. The charging device of the claim 5, wherein the charging device is installed on a table, and the signal processing unit receives external display information via the wireless communicating unit and processing the external information and displays processed external display information on the display unit, wherein external display information is inputted by a manager.

7. The charging device of claim 6, wherein the external display information is inputted by the manager via a mobile device.

8. The charging device of claim 6, wherein the external display information is from a cloud server.

9. The charging device of claim 5, further comprising:
a speaker;
wherein the signal processing unit receives external audio data via the wireless communicating unit, and sends the received external audio data to the speaker to play after processing.

10. The charging device of claim 5, further comprising:
a microphone;
wherein the signal processing unit further receives audio data from the microphone, and sends the audio data via the wireless communicating unit.

11. The charging device of claim 1, further comprising:
an electronic anti-theft element, comprising at least one of a Radio Frequency Identification (RFID) function, burglarproof magnetic strip, RF soft anti-theft barcode, AM DR soft anti-theft label, acoustic magnetic anti-theft label.

12. The charging device of claim 1, further comprising:
a signal feedback unit, coupled to the display unit, arranged for controlling an open/close state of the display unit or controlling a level of power consumption of the display unit.

13. A charging device, fixed or placed on a table or a wall to serve as a signage, comprising:
a display unit, arranged for displaying information;
a power supply unit, arranged for providing power to the charging device, wherein the power supply unit comprises at least a wireless charging module;
wherein when an external electronic device is placed in a charging range of the wireless charging module, the wireless charging module charges the external electronic device.

14. The charging device of claim 13, further comprising:
a wireless communicating unit;
a signal processing unit, coupled to the wireless communicating unit, arranged for communicating with other electronic devices via the wireless communicating unit, and processing received data via the wireless communicating unit.

15. The charging device of claim 14, wherein the charging device is installed on a table, and the signal processing unit receives external display information via the wireless communicating unit and displays the external display information after processing, wherein the external display information is inputted by a manager.

16. The charging device of claim 14, further comprising:
a speaker;
wherein the signal processing unit receives external audio data via the wireless communicating unit, and sends the received external audio data to the speaker to play after processing.

17. The charging device of claim 14, further comprising:
a microphone;
wherein the signal processing unit further receives audio data received from the microphone, and sends the audio data via the wireless communicating unit.
